(19) United States
(12) Patent Application Publication
(10) Pub. No.: US 2006/0156923 A1
(43) Pub. Date: Jul. 20, 2006

(54) Method for the deacidification of a fluid stream by means of an inert scrubbing column and corresponding device

(75) Inventors: Stefan Meckl, Wachenheim (DE); Norbert Asprion, Mannheim (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 10/559,143

(22) PCT Filed: May 29, 2004
(86) PCT No.: PCT/EP04/05849

§ 371 Date: Dec. 1, 2005

(30) Foreign Application Priority Data
Jun. 5, 2003 (DE) 103 25 358.0
Jul. 25, 2003 (DE) 103 34 002.5

(51) Int. Cl. B01D 53/14

(52) U.S. Cl. 95/236

(57) ABSTRACT

A process for deacidifying a fluid stream containing acid gases as impurities, which comprises, in at least one absorption step at a pressure of from 0.5 to 20 bar, bringing the fluid stream into intimate contact with an absorbent with the proviso that the absorption step, and in the case of a plurality of absorption steps at least one of the absorption steps, is carried out in an inert scrubbing column, the internal surface of which essentially consists of plastic or rubber.

The present invention relates to a process for deacidifying a fluid stream containing acid gases as impurities, and an apparatus therefor.

In numerous processes in the chemical industry fluid streams occur which contain, as impurities, acid gases, for example CO₂, H₂S, SO₂, CS₂, HCN, COS or mercaptans. These fluid streams can be, for example, gas streams (such as natural gas, refinery gas, reaction gases produced in the oxidation of organic materials, for example organic wastes, coal or mineral oil, or in the composting of waste materials containing organic substances).

The removal of the acid gases is of particular importance for varying reasons. For example the content of sulfur compounds in natural gas must be reduced directly at the natural gas source by suitable treatment measures, since the sulfur compounds form acids in the water frequently entrained by the natural gas, which acids act corrosively. For transporting the natural gas in a pipeline, therefore, preset limiting values of the sulfur-containing impurities must be complied with. The reaction gases produced in the oxidation of organic materials, for example organic wastes, coal or mineral oil, or in the composting of waste materials containing organic substances must be removed in order to prevent the emission of gases which damage the natural environment or affect the climate.

On the scrubbing solutions used in gas scrubbing processes, there is also an extensive patent literature. In principle, a distinction can be made between two different types of absorbents or solvents for gas scrubbing:

Firstly, what are termed physical solvents are used, in which, after absorption has been completed, the dissolved acid gases are present in molecular form. Typical physical solvents are cyclotetramethylene sulfone (sulfolane) and derivatives thereof, aliphatic acid amides (acetylmorpholine, N-formylmorpholine), NMP (N-methylpyrrolidone), propylene carbonate, N-alkylated pyrrolidones and corresponding piperidones, methanol and mixtures of dialkyl ethers of polyethylene glycols (Selexol®, Union Carbide, Danbury, Conn., USA).

Secondly, chemical solvents are used, the mode of action of which is based on chemical reactions, in which after absorption has been completed, the dissolved acid gases are present in the form of chemical compounds. For example, in the case of the aqueous solutions of inorganic bases (for example potash solution in the Benfield process) or organic bases (for example alkanolamines), which are the most frequently used as chemical solvents on an industrial scale, ions are formed when acid gases are dissolved. The solvent can be regenerated by expansion to a lower pressure or by stripping, the ionic species reacting back to acid gases and/or being stripped off by steam. After the regeneration process the solvent can be reused. Preferred alkanolamines used in the removal of acid gas impurities from hydrocarbon gas streams comprise monoethanolamine (MEA), diethanolamine (DEA), triethanolamine (TEA), diethylethanolamine (DEEA), diisopropylamine (DIPA), aminoethoxyethanol (AEE) and methyldiethanolamine (MDEA).

For the absorption of the acid gases, the fluid streams are brought into contact in an absorption step with the scrubbing solution. “Gas Purification”, Arthur Kohl, Richard Nielsen, Gulf Publishing Company, Houston, Tex., 1997, 5th edition, Chapter 3, Subchapter Amine Plant Corrosion, 187-230 discloses carrying out this absorption step in steel scrubbing columns. At the same time it is described, (loc. cit.), that the steel, if expensive high-alloy steels are not used, is attacked by corrosion due to the acid gas content. This considerably decreases the service life of the plants.

It is an object of the present invention, therefore, to provide an apparatus for the absorption of acid gases from fluid streams comprising a scrubbing column in which the scrubbing column is substantially inert toward the fluid streams.

We have found that this object is achieved by a process for deacidifying a fluid stream containing acid gases as impurities, which comprises, in at least one absorption step at a pressure of from 0.5 to 20 bar, bringing the fluid stream into intimate contact with an absorbent with the proviso that the absorption step, and in the case of a plurality of absorption steps at least one of the absorption steps, is carried out in an inert scrubbing column, the internal surface of which essentially consists of plastic or rubber.

The fluid stream, usually a starting gas (crude gas) rich in acid gas constituents, in an absorption step is brought into contact with an absorbent in an inert scrubbing column, as a result of which the acid gas constituents are at least partially scrubbed out.

The starting gas is generally natural gas or a gas stream which is formed in the following ways:
a) the oxidation of organic substances,
b) the composting or storage of waste materials containing organic substances, or
c) the bacterial decomposition of organic substances.

Organic substances which are subjected to an oxidation are customarily fossil fuels such as coal, natural gas or mineral oil or waste materials containing organic substances.

As waste materials containing organic substances which are subjected to oxidation, composting or storage, use is principally made of domestic refuse, plastic waste or packaging waste.

The organic substances are usually oxidized by air in conventional incineration plants.

Waste materials containing organic substances are generally composted and stored at refuse landfills.

Organic substances which are usually used in the bacterial decomposition are stable manure, straw, liquid manure, sewage sludge, fermentation residues.

The bacterial decomposition takes place, for example, in conventional biogas plants.

These gas streams generally contain less than 50 mg/m³ of sulfur dioxide under standard conditions.

The starting gases can either have the pressure which roughly corresponds to the pressure of the ambient air, for example atmospheric pressure, or a pressure which deviates by up to 0.2 bar from atmospheric pressure. In addition, the starting gases can have a pressure higher than 0.2 bar above atmospheric pressure, a pressure up to 20 bar. Starting gases having a pressure higher than atmospheric pressure are formed by the starting gases at the pressure which is in the vicinity of the pressure of the ambient air being compressed, or the starting gas being produced at an elevated pressure, for example by oxidizing organic substances with compressed air. The resultant volumetric flow rate of the gas is thereby reduced and, in addition, the partial pressure of the acid gases to be removed increases, which is advantageous for the absorption and the resultant regeneration requirement. Disadvantages are firstly the compression costs (capital costs and running costs) and any higher capital costs resulting in addition owing to the use of the pressure apparatuses, so that there is here a cost optimum.

Suitable absorbents are virtually all customary absorbents.

Preferred absorbents are, for example, chemical solvents selected from the group consisting of
solutions consisting primarily of aliphatic or cycloaliphatic amines having from 4 to 12 carbons, alkanolamines having from 4 to 12 carbons, cyclic amines where 1 or 2 nitrogens together with 1 or 2 alkanediyl groups form 5-, 6- or 7-membered rings, mixtures of the above solutions, aqueous solutions of the above mixtures and solutions,
aqueous solutions containing salts of amino acids
aqueous potash solutions optionally containing piperazine or methylethanolamine
aqueous NaOH solutions or milk of lime.

Particularly preferably, use is made, as chemical solvents, of solutions principally consisting of monoethanolamine (MEA), diethanolamine (DEA), triethanolamine (TEA), diethylethanolamine (DEEA), diisopropylamine (DIPA), aminoethoxyethanol (AEE) and methyldiethanolamine (MDEA), mixtures of the above solutions and aqueous solutions of the above mixtures and solutions.

The absorbent described in U.S. Pat. No. 4,336,233 is very particularly proven. It is an aqueous solution of methyldiethanolamine (MDEA) and piperazine as absorption accelerator or activator (aMDEA®, BASF AG, Ludwigshafen). The scrubbing liquid described there contains from 1.5 to 4.5 mol/l of methyldiethanolamine (MDEA) and from 0.05 to 0.8 mol/l, preferably up to 0.4 mol/l, of piperazine.

Regarding further preferred chemical solvents, reference is made to DE-A-10306254, DE-A-10210729, DE-A-10139453, and EP-A-1303345.

Proven absorbents are, in addition, physical solvents selected from the group consisting of cyclotetramethylene sulfone (sulfolane) and derivatives thereof, aliphatic acid amides (acetylmorpholine, N-formylmorpholine), NMP (N-methylpyrrolidone), propylene carbonate, N-alkylated pyrrolidones and corresponding piperidones, methanol and mixtures of dialkyl ethers of polyethylene glycols.

The inert scrubbing columns used in the inventive process consist essentially of plastics selected from the group consisting of polyvinyl chloride, polyethylene, polypropylene, polyvinylidene fluoride, ethylene-chlorotrifluoroethylene copolymers (Halar® from Allied Chemical Corp.), polyfluoroethylenepropylene, perfluoroalkoxy polymers, copolymers of tetrafluoroethylene and perfluorovinyl ethers, polytetrafluoroethylene. Preferably, these plastics are glass-fiber reinforced. Further suitable scrubbing columns are steel scrubbing columns the interior of which is coated with plastic or rubber.

Suitable inert scrubbing columns are, for example, randomly packed columns, ordered-packing columns and plate columns. Preferably, only inert scrubbing columns are used as absorbers, though it is likewise possible to use these in combination with other known absorbers, such as membrane contactors, radial stream scrubbers, jet scrubbers, Venturi scrubbers and rotary spray scrubbers or steel scrubbing columns. The fluid stream is preferably treated with the absorbent in an inert scrubbing column in countercurrent. The fluid is generally fed into the lower region and the absorbent into the upper region of the column.

The temperature of the absorbent in the absorption step is generally from about 40 to 100° C., when one column is used, for example from 40 to 70° C. at the top of the column and from 50 to 100° C. at the bottom of the column. The overall pressure in the absorption step is generally from about 0.5 to 20 bar, preferably from about 0.7 to 12 bar, particularly preferably from 0.7 to 6 bar. Very particularly preferably, the pressure is atmospheric pressure or a pressure which deviates from atmospheric pressure by up to 0.2 bar. A product gas (secondary gas) which is low in acid gas constituents, that is to say is depleted in these constituents, and an absorbent loaded with acid gas constituents are obtained.

Generally, plastic absorption columns are only used up to a pressure of 5 bar, because of their construction. Although the use of plastic absorption columns is possible in principle at higher pressures, in such cases, because of the generally lower strength of the plastic compared with steel, comparatively high wall thicknesses are required. At pressures of above 5 bar, therefore, steel absorption columns, the interior of which is coated with plastic or rubber, are preferred.

The inventive process can comprise one or more, in particular two, sequential absorption steps. The absorption can be carried out in a plurality of sequential partial steps, the crude gas containing the acid gas constituents being brought into contact in each of the partial steps with in each case one substream of the absorbent. The absorbent with which the crude gas is brought into contact can already be partly loaded with acid gases, that is to say it can be an absorbent which has been recirculated from a subsequent absorption step to the first absorption step, or be a partially regenerated absorbent. Regarding carrying out the two-stage absorption, reference is made to the publications EP-A 0 159 495, EP-A 0 20 190 434, EP-A 0 359 991 and WO 00100271.

According to a preferred embodiment, the inventive process is carried out in such a manner that the fluid containing the acid gases is initially treated in a first absorption step with the absorbent at a temperature of from 40 to 100° C., preferably from 50 to 90° C., and in particular from 60 to 90° C. The fluid depleted in acid gases is then treated with the absorbent in a second absorption step at a temperature of from 30 to 90° C., preferably from 40 to 80° C., and in particular from 50 to 80° C. The temperature here is lower than in the first absorption stage by from 5 to 20° C.

The acid gas constituents can be released from the absorbent loaded with the acid gas constituents in a regeneration step in a conventional manner (similar to the publications cited below), a regenerated absorbent being obtained. In the regeneration step, the loading of the absorbent is decreased and the resultant regenerated absorbent is preferably then recirculated to the absorption step.

Generally, the regeneration step comprises at least one pressure expansion of the loaded absorbent from a high pressure, as prevails when the absorption step is being carried out, to a lower pressure. The pressure expansion can be achieved, for example, by means of a throttle valve and/or an expansion turbine. The regeneration using an expansion stage is described, for example, in the publications U.S. Pat. No. 4,537,753 and U.S. Pat. No. 4,553,984.

The acid gas constituents can be released in the regeneration step, for example, in an expansion column, for example a vertically or horizontally installed flash vessel, or in a countercurrent column fitted with internals. A plurality of expansion columns can be connected in series, in which regeneration is performed at differing pressures. For example, regeneration can be carried out in a preliminary expansion column at high pressure which is typically approximately 1.5 bar above partial pressure of the acid gas constituents in the absorption step, and in a main expansion column at low pressure, for example from 1 to 2 bar absolute. Regeneration using two or more expansion stages is described in the publications U.S. Pat. No. 4,537,753, U.S. Pat. No. 4,553,984, EP-A 0 159 495, EP-A 0 202 600, EP-A 0 190 434 and EP-A 0 121 109.

The last expansion stage can also be carried out under a vacuum which is produced, for example, by means of a steam jet, optionally in combination with a mechanical vacuum generator, as described in EP-A 0 159 495, EP-A 0 202 600, EP-A 0 190 434 and EP-A 0 121 109 (U.S. Pat. No. 4,551,158).

Because of the optimum matching of the content to the amine components, the inventive absorbent has a high loading capacity with acid gases which can also be readily desorbed again. As a result, in the inventive process, the energy consumption and the solvent recirculation can be significantly reduced.

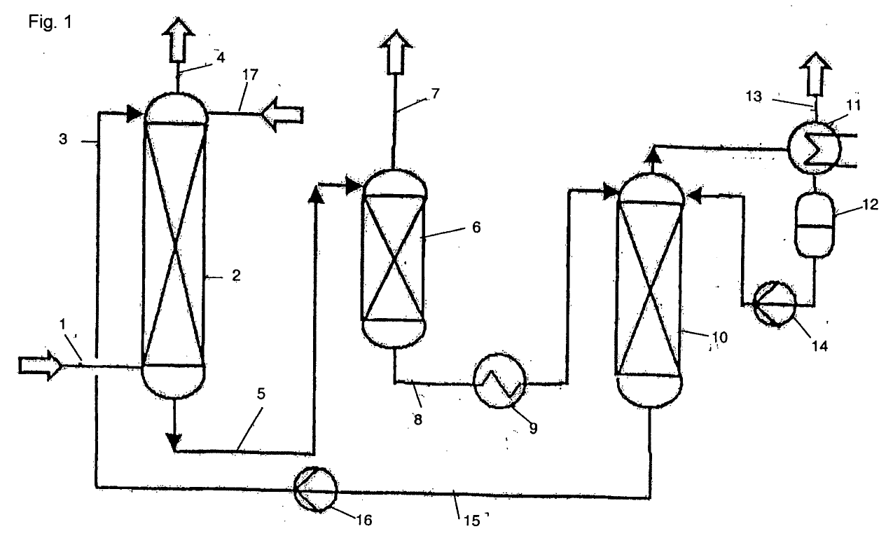

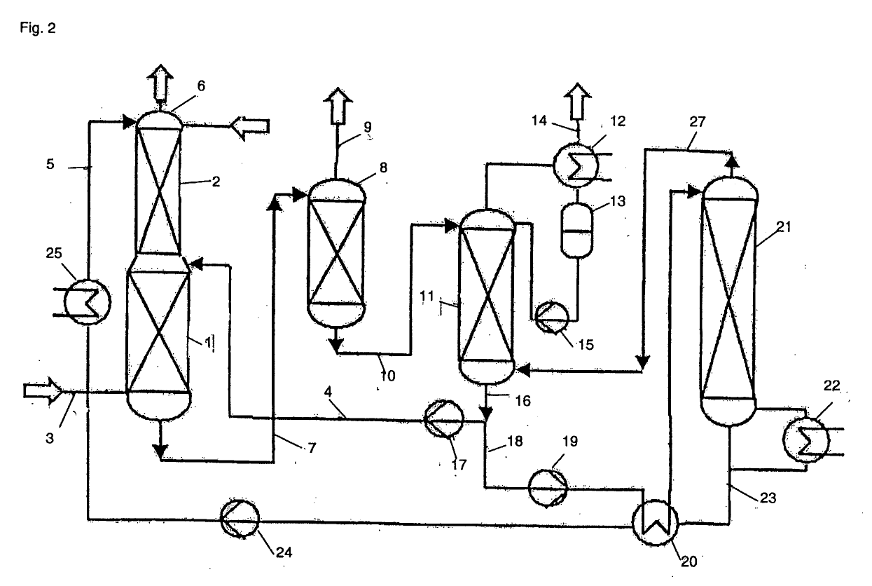

The inventive process is illustrated below with reference to FIGS. 1 and 2.

FIG. 1 diagrammatically shows an apparatus in which the absorption stage is carried out in a single stage and the expansion stage is carried out in two stages. The starting gas (hereinafter also termed feed gas) is fed via line 1 into the lower region of the absorber 2. The absorber 2 is a column packed with random packing elements to effect the mass transfer and heat exchange. The absorbent, which is a regenerated absorbent having a low residual content of acid gases, is delivered via the line 3 to the top of the absorber 2 in countercurrent to the feed gas. The gas depleted in acid gases leaves the absorber 2 overhead (line 4). The absorbent loaded with acid gases leaves the absorber 2 at the bottom via line 5 and is introduced into the upper region of the high-pressure expansion column 6 which is generally operated at a pressure which is above the CO₂ partial pressure of the crude gas fed to the absorber. The absorbent is generally expanded using conventional apparatuses, for example a level-control valve, a hydraulic turbine or a pump running in reverse. In the expansion, the majority of the dissolved non-acid gases and also a small part of the acid gases are released. These gases are ejected from the high-pressure expansion column 6 overhead via line 7.

The absorbent, which is still loaded with the majority of the acid gases, leaves the high-pressure expansion column via line 8 and is heated in the heat exchanger 9, in which a small part of the acid gases can be released. The heated absorbent is introduced into the upper region of a low-pressure expansion column 10 which is equipped with a random packing, to achieve a high surface area and thus effect the release of the CO₂ and to effect equilibrium. In the low-pressure expansion column 10, the majority of the CO₂ and the H₂S is virtually completely released by flashing. The absorbent is simultaneously regenerated and cooled in this manner. At the top of the low-pressure expansion column 10, a reflux condenser 11 together with a collection vessel 12 are provided, in order to cool the released acid gases and condense a part of the vapor. The majority of the acid gas leaves the reflux condenser 11 via line 13. The condensate is pumped back by means of pump 14 to the top of the low-pressure expansion column 10. The regenerated absorbent, which still contains a small part of the CO₂, leaves the low-pressure expansion column 10 at the bottom via line 15 and is applied to the top of the absorber 2 via line 3 by means of pump 16. Via line 17, fresh water can be fed in to make up for the water discharged with the gases.

FIG. 2 shows diagrammatically an apparatus for carrying out the inventive process, using a two-stage absorber and a two-stage expansion. The absorber comprises the crude absorber 1 and the clean absorber 2. The feed gas is fed via line 3 into the lower region of the crude absorber 1 and treated in countercurrent with regenerated absorbent which is applied to the top of the crude absorber 1 via line 4 and still contains some acid gases. Regenerated absorbent which essentially no longer contains acid gases is applied to the top of the clean absorber 2 via line 5. Both parts of the absorber contain an ordered packing in order to effect the mass transfer and heat exchange between crude gas and absorbent. The treated gas leaves the clean absorber 2 overhead (line 6). The absorbent loaded with acid gases is discharged at the bottom of the crude absorber 1 and is fed via line 7 into the upper region of the high-pressure expansion column 8. The column 8 is equipped with an ordered packing and is operated at a pressure which is between the pressure in the absorber and the subsequent low-pressure expansion column 11. The absorbent loaded with acid gases is expanded using conventional apparatuses, for example a level-control valve, a hydraulic turbine or a pump running in reverse. In the high-pressure expansion, the majority of the dissolved non-acid gases and a small part of the acid gases are released. These gases are ejected from the high-pressure expansion column 8 overhead via line 9.

The absorbent, which is still loaded with the majority of the acid gases, leaves the high-pressure expansion column 8 via line 10 and is fed into the upper region of the low-pressure expansion column 11 where the majority of the CO₂ and H₂S are released by flashing. The absorbent is regenerated in this manner. The low-pressure expansion column 11 is equipped with an ordered packing to provide a high surface area for the heat exchange and mass transfer. A reflux condenser 12 together with condensate vessel 13 is provided at the top of the low-pressure expansion column 11 to cool the acid gases exiting from the low-pressure expansion column 11 overhead and to condense a part of the vapor. The non-condensed gas which contains the majority of the acid gases is discharged via line 14. The condensate from the condensate vessel 13 is applied to the top of the low-pressure expansion column 11 via pump 15.

The partially regenerated absorbent which still contains a part of the acid gases leaves the low-pressure expansion column 11 at the bottom via line 16 and is divided into two substreams. The larger substream is applied to the top of the crude absorber 1 via pump 17 and line 4, whereas the smaller part is heated in the heat exchanger 20 via line 18 by means of pump 19. The heated absorbent is then fed into the upper region of the stripper 21 which is equipped with an ordered packing. In the stripper 21, the majority of the absorbed CO₂ and H₂S is stripped out by vapor which is produced in the reboiler 22 and is fed into the lower region of the stripper 21. The absorbent leaving the stripper 21 at the bottom via line 23 has only a low residual content of acid gases. It is passed through the heat exchanger 20, with the partially regenerated absorbent coming from the low-pressure expansion column 11 being heated. The cooled regenerated absorbent is pumped by means of pump 24 through heat exchanger 25 back to the top of the clean absorber 2. Fresh water can be applied to the top of the clean absorber 2 via line 26 to replace the water discharged by the gas streams. The gas exiting overhead from the stripper 21 is fed via line 27 to the lower region of the low-pressure expansion column 11.

1. A process for deacidifying a fluid stream containing acid gases as impurities, which comprises, in at least one absorption step at a pressure of from 0.5 to 20 bar, bringing the fluid stream into intimate contact with an absorbent with the proviso that the absorption step, and in the case of a plurality of absorption steps at least one of the absorption steps, is carried out in an inert scrubbing column, the internal surface of which essentially consists of plastic or rubber.

2. A process as claimed in claim 1, wherein the fluid stream is formed in
a) the oxidation of organic substances,
b) the composting or storage of waste materials containing organic substances, or
c) the bacterial decomposition of organic substances.

3. A process as claimed in claim 2, wherein the organic substances which are subjected to oxidation are fossil fuels or waste materials containing organic substances.

4. A process as claimed in claim 2, wherein the waste materials which contain organic substances and are subjected to composting or storage are domestic refuse, plastic wastes or packaging waste.

5. A process according to claim 2, wherein the organic substances which are subjected to bacterial decomposition are stable manure, straw, liquid manure, sewage sludge or fermentation residues.

6. A process as claimed in claim 1, wherein inert scrubbing columns are used which essentially consist of glass fiber reinforced plastics selected from the group consisting of polyvinyl chloride, polyethylene, polypropylene, polyvinylidene fluoride, ethylene-chlorotrifluoroethylene copolymers, Halar, polyfluoroethylenepropylene, perfluoroalkoxy polymers, copolymers of tetrafluoroethylene and perfluorovinyl ethers, polytetrafluoroethylene.

7. A process as claimed in claim 1, wherein an inert steel scrubbing column is used the interior of which is coated with rubber.

8. A process as claimed in claim 1, wherein the absorbent is a chemical solvent selected from the group consisting of
solutions consisting primarily of aliphatic or cycloaliphatic amines having from 4 to 12 carbons, alkanolamines having from 4 to 12 carbons, cyclic amines where 1 or 2 nitrogens together with 1 or 2 alkanediyl groups form 5-, 6- or 7-membered rings, mixtures of the above solutions, aqueous solutions of the above mixtures and solutions,
aqueous solutions containing salts of amino acids
aqueous potash solutions optionally containing piperazine or methylethanolamine
aqueous NaOH solutions or milk of lime.

9. A process as claimed in claim 8, wherein, as chemical solvent, use is made of solutions consisting primarily of monoethanolamine (MEA), methylaminopropylamine (MAPA), piperazine, diethanolamine (DEA), triethanolamine (TEA), diethylethanolamine (DEEA), diisopropylamine (DIPA), aminoethoxyethanol (AEE), dimethylaminopropanol (DIMAP) and methyldiethanolamine (MDEA), mixtures of the above solutions and aqueous solutions of the above mixtures and solutions.

10. A process as claimed in claim 1, wherein the absorbent is a physical solvent selected from the group consisting of cyclotetramethylene sulfone (sulfolane) and derivatives thereof, aliphatic acid amides (acetylmorpholine, N-formylmorpholine), NMP (N-methylpyrrolidone), propylene carbonate, N-alkylated pyrrolidones and corresponding piperidones, methanol and mixtures of dialkyl ethers of polyethylene glycols.

11. A process as claimed in claim 1, wherein the scrubbing solution is a mixture of a physical solvent and a chemical solvent.

12. A process as claimed in claim 1, wherein the scrubbing solution is an aqueous solution comprising methyldiethanolamine and piperazine.

13. A process as claimed in claim 1, wherein the scrubbing liquid, after passing through the absorption step, is regenerated and then recirculated to an absorption step.

14. A process as claimed in claim 12, wherein the scrubbing liquid is regenerated by a single-stage or multistage expansion.

15. A process as claimed in claim 12, wherein the scrubbing liquid, after the expansion, is regenerated by stripping with an inert fluid, in particular nitrogen or steam.

16. A process as claimed in claim 1, wherein the absorption step is carried out in a plurality of sequential substeps and the acid-gas-containing fluid stream, in each of the substeps, is brought into contact in each case with one substream of the scrubbing solution.

17. A process as claimed in claim 1, wherein a fluid stream is used which, under standard conditions, contains less than 50 mg/m³ of sulfur dioxide.

18. An apparatus for carrying out the process as claimed in claim 1 consisting of one or more serially connected scrubbing columns which are charged with a scrubbing solution, at least one scrubbing column being an inert scrubbing column the internal surface of which consists of plastic or rubber.
